(19) United States
(12) Patent Application Publication
(10) Pub. No.: US 2017/0189142 A1
(43) Pub. Date: Jul. 6, 2017

(54) Apparatus and Method to Design Dentures

(71) Applicant: Stephen A. Wagner, Albuquerque, NM (US)

(72) Inventor: Stephen A. Wagner, Albuquerque, NM (US)

(21) Appl. No.: 15/397,464

(22) Filed: Jan. 3, 2017

Related U.S. Application Data
(60) Provisional application No. 62/274,064, filed on Dec. 31, 2015.

(51) Int. Cl. A61C 13/00; A61C 11/08; B33Y 50/02; G05B 19/4099; B29C 67/00; B33Y 10/00; A61C 13/34; A61C 9/00

(52) U.S. Cl. CPC A61C 13/0004; A61C 13/0019; A61C 13/34; A61C 13/0028; A61C 11/088; A61C 11/087; A61C 9/004; A61C 9/0006; G05B 19/4099; B29C 67/0088; B33Y 10/00; B33Y 50/02; G05B 2219/35134; G05B 2219/49007

(57) ABSTRACT

A method and apparatus for the design and manufacture of dentures wherein the number of office visits that a patient must attend in order to develop and obtain dentures is reduced. In one embodiment, during a first visit, final impressions and a measurement of the patient's upper lip is obtained. In one embodiment, a lab then creates a denture base and applies tooth replicas. In one embodiment, this is done using a physical fabrication aid of an embodiment of the present invention. Alternatively, the denture base can be created from a digital representation, and the denture base is then preferably sized and adjusted during the patient's second visit before final dentures are created and provided to the patient during the patient's third visit.

### CROSS-REFERENCE TO RELATED APPLICATIONS

This application claims priority to and the benefit of the filing of U.S. Provisional Patent Application Ser. No. 62/274,064, entitled “Apparatus and Method to Design Dentures”, filed on Dec. 31, 2015, and the specification thereof is incorporated herein by reference.

### BACKGROUND OF THE INVENTION

Field of the Invention (Technical Field)

Embodiments of the present invention relate to dentures, and more particularly to methods and apparatuses to expedite the production and improve the quality of dentures.

Description of Related Art

Artificial dentures are prosthetics, often made mostly of plastic, that replace missing or lost teeth. Current analog methods of designing and fitting artificial dentures are time consuming, expensive for the patient and unprofitable for practitioners. The known methods usually involve five visits or more to the dentist's office in order to diagnose, select artificial teeth, determine size and color, obtain primary impressions for molds, create models from the molds, take secondary impressions using custom baseplates, fit, tryout, customize dentures and make adjustments, and finish the dentures. The traditional technique for obtaining dentures typically involve:
First visit: Obtain preliminary impressions;
Second visit: Obtain final impressions and select teeth;
Third visit: Determine anterior tooth position, determine jaw relationship, and determine occlusal plane;
Fourth visit: Try in and obtain patient approval; and
Fifth visit: Deliver finished prosthesis.

Fabrication of the dentures themselves in a dental lab usually involves waxing of models mounted on an articulator which simulates movement of the patient's jaws, positioning of artificial teeth in order to approximate occlusal relationships, and casting the dentures in plaster molds made from the waxed up models.

There is thus a present and long-felt need for a method and apparatus for production of dentures with fewer patient visits to the dentist's office with the same or improved results. Embodiments of the present invention address this need by providing methods and apparatuses to produce excellent quality dentures with fewer visits.

### BRIEF SUMMARY OF EMBODIMENTS OF THE PRESENT INVENTION

An embodiment of the present invention relates to a method for providing dentures to a patient in three visits, the method including obtaining final impressions and a measurement of an upper lip of the patient during a first visit, sizing and adjusting the denture base during a second visit, and delivering the dentures to the patient during a third visit. The method can also include creating a denture base after the first visit but before the second visit. In one embodiment, the method can also include providing a fabrication apparatus having an inclined platform with a top surface that is inclined at an angle of from 14 degrees to 20 degrees from horizontal when disposed in its intended operating position, and a papilla pin extending through the inclined platform, and disposing at least a portion of the denture base on the fabrication apparatus and placing tooth replicas on the denture base. The method can also include disposing the fabrication apparatus on an articulator and/or positioning a tube on the inclined platform in a location that corresponds with hamular notches on the denture base. In one embodiment, the method can also comprise adjusting the papilla pin to correspond at least substantially to the measurement of the patient's upper lip that was obtained during the first visit. The dentures can be constructed based on the denture base after the second visit and before the third visit.

In one embodiment, obtaining final impressions can include using a universal impression tray to obtain the final impressions. The method can also include obtaining a 3D digital representation of the final impressions and storing it on non-transitive computer readable media. Creating a denture base can include performing a computer numeric controlled operation to generate a physical denture base and performing a computer numeric controlled operation can itself include performing computer controlled milling of a base material. Optionally, performing a computer numeric controlled operation can include performing a computer controlled 3D printing operation.

In one embodiment, the method does not include a visit during which anterior tooth position is determined and/or does not include a visit during which an occlusal plane of the patient is determined prior to construction of a denture base. In one embodiment, an occlusal plane is determined based on a predetermined number. The predetermined number can optionally comprise an average or typical or common occlusal plane. Optionally, digital representations of tooth replicas can be placed along a digital representation of the occlusal plane by a processor operating on instructions in software in non-transitive computer readable media. Alternatively, the digital representations of tooth replicas can be placed by a lab technician on a virtual representation of a denture base.

An embodiment of the present invention relates to a fabrication apparatus having an inclined platform with a top surface that is inclined at an angle of from 14 degrees to 20 degrees from horizontal when disposed in its intended operating position, a papilla pin extending through the inclined platform; and a tube movably positionable with respect to the inclined platform. The top surface can be inclined at an angle of at least substantially 17 degrees from horizontal. The papilla pin can include a threaded shaft. The tube can include one or more magnets and the inclined platform can include a ferrous material.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a schematic representation of a method for designing custom dentures according to an embodiment of the present invention;

FIGS. 2, 3, and 4 are perspective-view drawings which respectively illustrate an elevated front, an elevated side, and a top of a denture fabrication aid according to an embodiment of the present invention;

FIGS. 5 and 6 are perspective side-view drawings which illustrate a fabrication aid according to an embodiment of the present invention which is disposed on a known articulator; and

FIG. 7 is a drawing which illustrates modified denture tooth replicas attached to a singe sprue according to an embodiment of the present invention.

### DETAILED DESCRIPTION OF THE INVENTION

Embodiments of the present invention shorten the number of visits needed for production of customized, high quality dentures from five to three visits of approximately the same length of time.

The term “first visit” as used throughout this application is used within the context of dental visits and/or appointments to obtain dentures. Thus the term “first visit” is not intended to mean the first time that a person ever visits a dental office in his or her life. The terms “second visit”, “third visit”, “fourth visit”, and “fifth visit” as used throughout this application are also intended be used within the context of dental visits and/or appointments to obtain dentures.

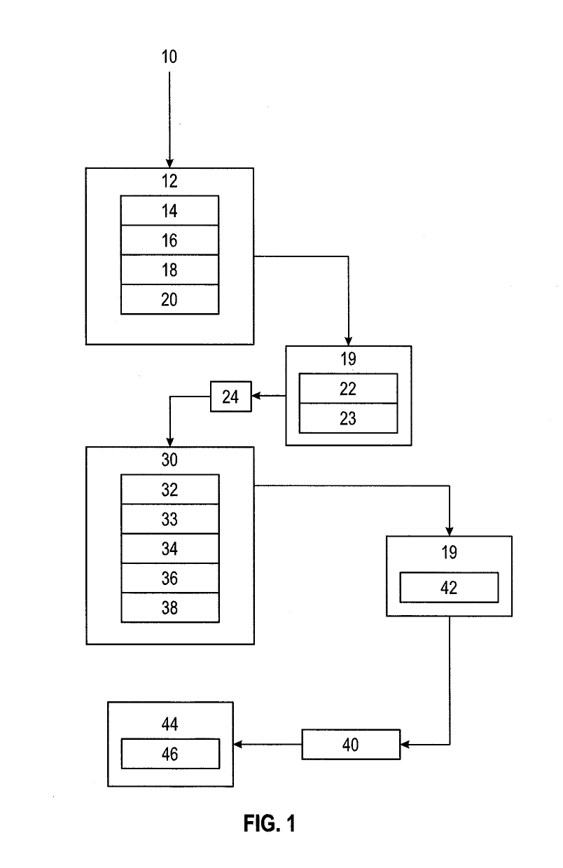

Referring to the drawings, and more particularly to FIG. 1, there is diagrammed an embodiment of the present invention for a method of dentures production 10 comprising first visit 12 that includes diagnosing 14 the patient, selecting 16 artificial teeth, obtaining 18 final impressions for molds and measuring 20 the patient's upper lip length, most preferably with a papillameter. Preferably, the dentist sends 19 the final impressions to a dental lab for creating 22 casts of the patient's gums and forming 23 the denture base. In one embodiment, once the denture base is formed, the lab places it onto fabrication aid apparatus 100 where papilla pin 118 is adjusted and inclined platform 110 is used as a guide to determine tooth placement (these use steps are described in more detail below). In an alternative embodiment, the lab then sends 24 the denture base to the dentist office.

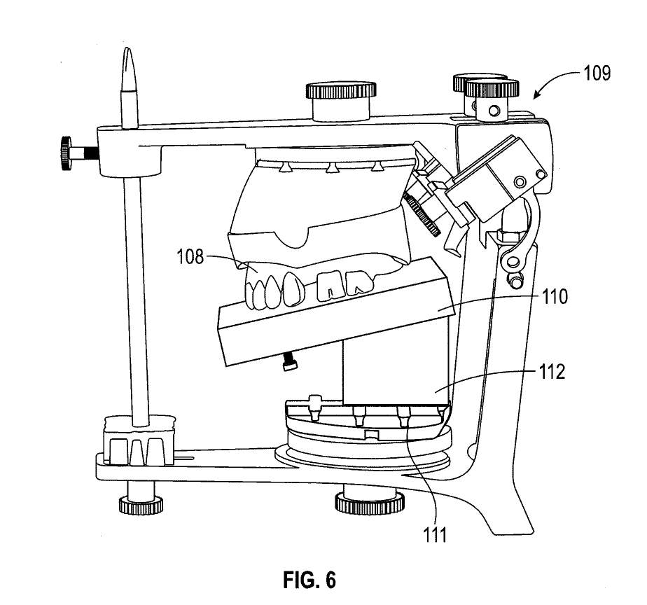

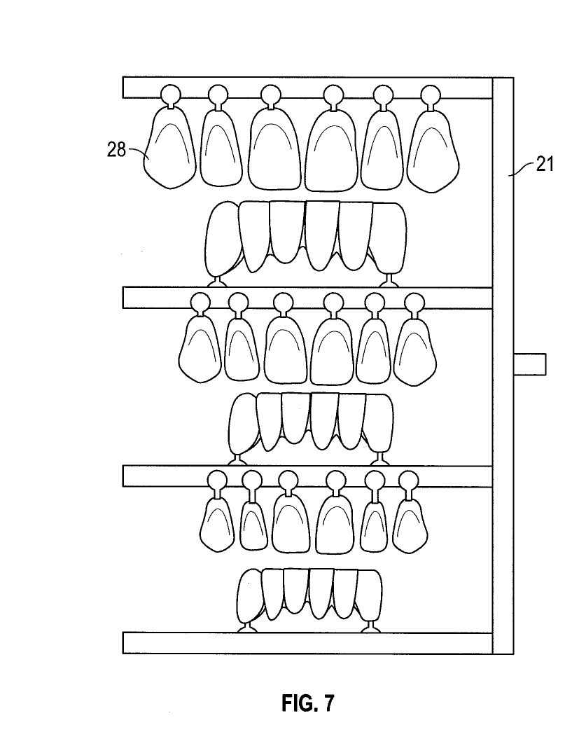

During second visit 30, the dentist preferably sizes 32 denture bases, and adjusts 33 the denture bases for the placement of tooth replicas 28 (see FIG. 7), by for example, placing denture base 108 (see FIG. 6) in warm water for a few seconds for the wax-like polymer to soften. Preferably, second visit 30 further comprises marking vertical dimensions 34 of occlusion, for example on the wax, recording 36 the inter-occlusal spaces on recording medium, requesting 38 patient approval, and sending 19 the marked denture bases back to a lab for producing 42 the final prosthesis.

In the method, the dental lab then preferably sends 40 the final prosthesis, which includes denture base 108 with tooth replicas 28 back to the dentist office for third visit 44. Preferably, third visit 44 includes delivering 46 the final prosthesis to the patient.

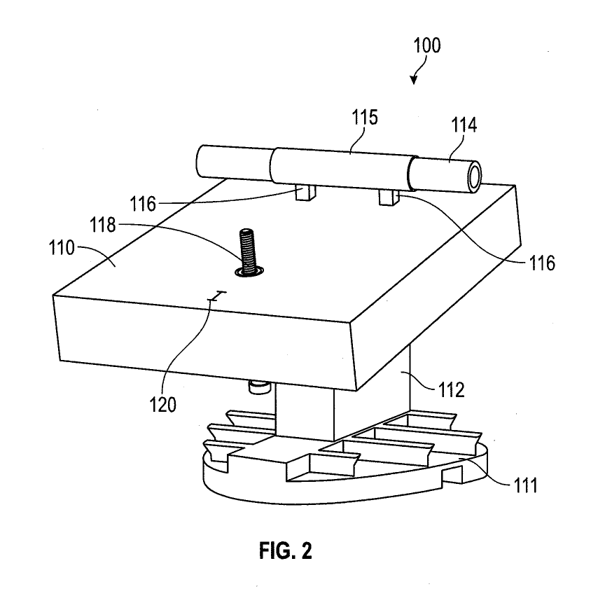

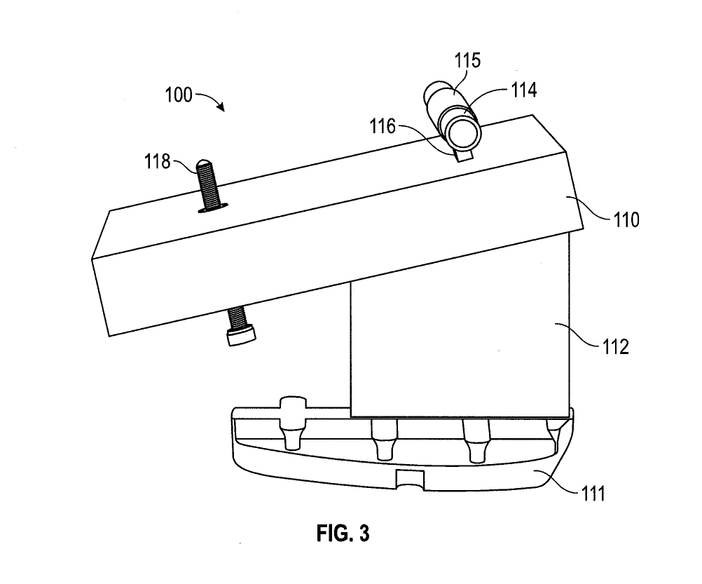

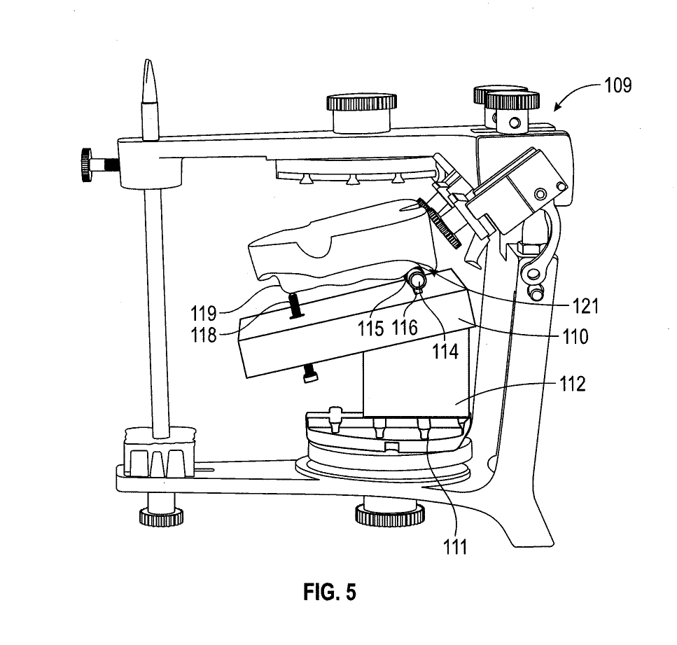

Referring now to FIGS. 2-6, preferably, the initial manufacturing of maxillary denture base 108 is accomplished in the lab with an embodiment of a denture fabrication aid apparatus such as the one shown in these figures mounted onto commercially available articulator 109. In one embodiment, denture fabrication aid apparatus 100 comprises inclined platform 110 attached to base 112, which is preferably attachable to lower mounting ring 111 of articulator 109. In one embodiment, various versions of mounting rings compatible with commercially available articulators can be included with denture fabrication aid apparatus 100. Preferably, adjustable cast support rod 114 is disposed within tube 115, which itself is disposed on inclined platform 110. In one embodiment, cast support rod 114 has a cylindrical shape. Most preferably, tube 115 is connected to platform 110 via one or more magnets 116. Optionally, however, other methods, systems and mechanisms can be used to attach tube 115 to platform 110, including but not limited to pressure sensitive adhesive, hook and loop tape, putty, one or more tracks, including but not limited to T-slot tracks, formed in platform 110 in which one or more fasteners can be adjustably secured, combinations thereof, and the like. In one embodiment, a plurality of cast support rods 114 are preferably provided of various lengths so as to accommodate denture bases 108 of various widths. In this embodiment, a user simply slides cast support rod 114 out from tube 115 and inserts another cast support rod 114 of the desired length. Of course desirable results can be obtained by a structure other than tube 115 with rod 114 disposed therein. For example, in one embodiment, a single member can be used in place of rod 114, tube 115, and magnets 116. The term “tube” is thus intended to include any structure capable of supporting at least partially hamular notches of a denture base. The term “tube” is thus not limited to hollow elongated structures. In this embodiment, various lengths of the single member can be provided to accommodate various widths of denture bases 108.

Preferably, denture fabrication aid apparatus 100 further comprises adjustable incisive papilla pin 118 which can comprise a threaded inclusive papilla screw. In one embodiment, adjustable incisive papilla pin 118 can be adjusted to the size of the patient's upper lip, which size was preferably determined with a papiliameter. This can optionally be accomplished by cutting female threads into inclined platform 110 and/or by attaching a nut to inclined platform 110, which is most preferably attached by disposing the nut into a recess in inclined platform 110.

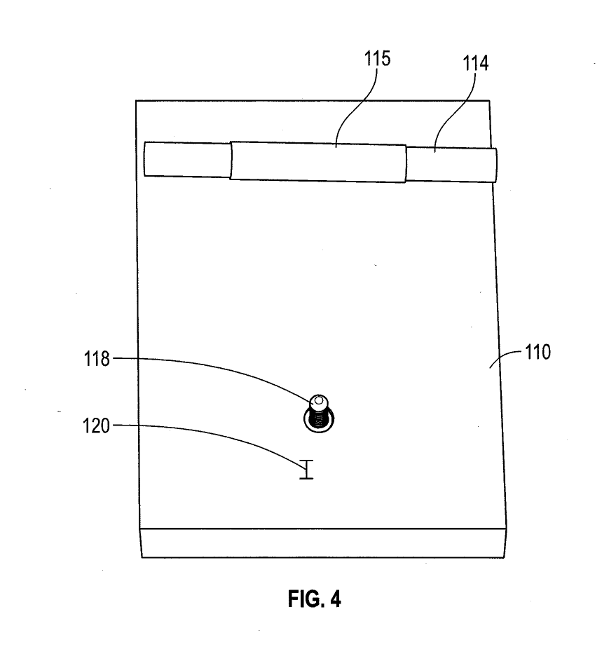

Once the incisive papilla pin 118 is protruding from the upper surface of inclined platform by the amount of the papillarneter measurement, incisive papilla point 119 of maxillary denture base 108 is placed on top of papilla pin 118. Hamular notches 121 of the maxillary cast are preferably disposed on cast support 114 so that the upper surface of inclined platform 110 provides the plane of occlusion for the artificial teeth in the maxillary denture base. Preferably an approximately 8 mm to 10 mm margin 120 is marked directly in front of incisive papilla pin 118 to give the lab technician an approximation of where the front teeth will be initially placed (see FIGS. 4-6).

Although the drawings illustrate an embodiment wherein inclined platform 110 is attached to base 112, which itself is attached to lower mounting ring 111, in one embodiment, all three of those components can be formed from a single continuous piece of material. In an alternative embodiment, inclined platform 110 and base 112 or base 112 and mounting ring 111 can be formed from a single continuous piece of material.

Preferably maxillary denture base 108 is initially fabricated in the lab and comprises artificial and wax-like polymer (for example, setup wax, or urethane set up resin) capable of holding the artificial front teeth in place but at the same time allowing the dentist to adjust them according to the patient's needs or preferences. In one embodiment, tooth replicas 28 can include denture tooth replicas. In one embodiment, tooth replicas are provided joined together in single sprue 21 (See FIG. 7). In one embodiment, tooth replicas 28 are detachable from sprue 21 and are preferably thinner than normal human teeth to facilitate placing them in different locations in the gums of denture bases 108, for example further back.

In one embodiment, inclined platform is preferably disposed at an angle of about 14 to about 20 degrees from horizontal when installed in its intended operating position and more preferably at an angle of about 17 degrees from horizontal.

In one embodiment, during the first visit to the dentist, the dentist preferably obtains final molds with a universal impression tray such as that described in U.S. Pat. No. 8,376,738. By using a universal impression tray during the first visit, the conventional 5-step visit technique as outHned in previously in this application, is able to be shortened to a four visit process by replacing conventional visits 1 and 2with the procedures identified herein with regard to first visit 12. Further, because apparatus 100 is preferably used by the lab to determine a good initial fit and form for placement of tooth replicas 28, conventional third visit, as outlined above, is able to be removed, thus further reducing the overall denture technique to only a three visit process.

In one embodiment, a scan of the patient's mouth or a scan of the final impressions obtained during the first visit can be scanned and input into a computer, most preferably via a 3D laser scanner, and subsequent steps can be performed in a computer and after designing, the denture base with tooth replicas can be output from the computer, for example by milling or via a 3D print. In one embodiment, the steps which can be implemented in a computer can be to construct a software implementation which implements apparatus 100. For example, the software code can assume a flat plane at an angle of from about 14 to about 20 degrees from horizontal and most preferably of about 17 degrees from horizontal on which the terminal end portions of the teeth, which themselves can be numerically represented in computer code, should align. Although the resulting denture can be illustrated graphically on a computer monitor, in one embodiment, the resulting denture base is preferably re-created physically by a computer numerical controlled (“CNC”) output, which can comprise, but is not limited to, a 3D printer, a computer controlled mill, combinations thereof and the like.

Optionally, embodiments of the present invention can include a general or specific purpose computer or distributed system programmed with computer software implementing steps described above, which computer software may be in any appropriate computer language, including but not limited to C++, FORTRAN, BASIC, Java, Python, Linux, assembly language, microcode, distributed programming languages, etc. The apparatus may also include a plurality of such computers distributed systems (e.g., connected over the Internet and/or one or more intranets) in a variety of hardware implementations. For example, data processing can be performed by an appropriately programmed microprocessor, computing cloud, Application Specific Integrated Circuit (ASIC), or the like, in conjunction with appropriate memory, network, and bus elements. One or more processors and/or microcontrollers can operate via instructions of the computer code and the software is preferably stored on one or more tangible non-transitive memory-storage devices.

Note that in the specification and claims, “about” or “approximately” means within twenty percent (20%) of the numerical amount cited. All computer software disclosed herein may be embodied on any non-transitory computer-readable medium (including combinations of mediums), including without limitation CD-ROMs, DVD-ROMs, hard drives (local or network storage device), USB keys, other removable drives, ROM, and firmware.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method for providing dentures to a patient in three visits, the method comprising:
obtaining final impressions and a measurement of an upper lip of the patient during a first visit;
sizing and adjusting the denture base during a second visit; and
delivering the dentures to the patient during a third visit.

2. The method of claim 1 further comprising creating a denture base after the first visit but before the second visit.

3. The method of claim 2 further comprising:
providing a fabrication apparatus comprising:
an inclined platform having a top surface that is inclined at an angle of from 14 degrees to 20 degrees from horizontal when disposed in its intended operating position; and
a papilla pin extending through said inclined platform; and
disposing at least a portion of the denture base on the fabrication apparatus and placing tooth replicas on the denture base.

4. The method of claim 3 further comprising disposing the fabrication apparatus on an articulator.

5. The method of claim 3 further comprising positioning a tube on the inclined platform in a location that corresponds with hamular notches on the denture base.

6. The method of claim 3 further comprising adjusting the papilla pin to correspond at least substantially to the measurement of the patient's upper lip that was obtained during the first visit.

7. The method of claim 2 wherein the dentures are constructed based on the denture base after the second visit and before the third visit.

8. The method of claim 1 where obtaining final impressions comprises using a universal impression tray to obtain final impressions.

9. The method of claim 2 further obtaining a 3D digital representation of the final impressions and storing it on non-transitive computer readable media.

10. The method of claim 9 wherein creating a denture base comprises performing a computer numeric controlled operation to generate a physical denture base.

11. The method of claim 10 wherein performing a computer numeric controlled operation comprises performing computer controlled milling of a base material.

12. The method of claim 10 wherein performing a computer numeric controlled operation comprises performing a computer controlled 3D printing operation,

13. The method of claim 1 wherein the method does not comprise a visit during which anterior tooth position is determined.

14. The method of claim 1 wherein the method does not comprise a visit during which an occlusal plane is determined prior to construction of a denture base.

15. The method of claim 9 wherein an occlusal plane is determined based on a predetermined number.

16. The method of claim 9 wherein digital representations of tooth replicas are placed along a digital representation of the occlusal plane by a processor operating on instructions in software in non-transitive computer readable media.

17. A fabrication apparatus comprising:
an inclined platform having a top surface that is inclined at an angle of from 14 degrees to 20 degrees from horizontal when disposed in its intended operating position;
a papilla pin extending through said inclined platform; and
a tube movably positionable with respect to said inclined platform.

18. The fabrication apparatus of claim 17 wherein said top surface is inclined at an angle of at least substantially 17 degrees from horizontal.

19. The fabrication apparatus of claim 17 wherein said papilla pin comprises a threaded shaft.

20. The fabrication apparatus of claim 17 wherein said tube comprises one or more magnets and wherein said inclined platform comprises a ferrous material.
